(19) United States
(12) Patent Application Publication
(10) Pub. No.: US 2025/0086143 A1
(43) Pub. Date: Mar. 13, 2025

(54) WORKLOAD-RESPONSIVE SEGMENT CLEANING

(71) Applicant: VMWare LLC, Palo Alto, CA (US)

(72) Inventors: Eric Knauft, San Francisco, CA (US); Sriram Patil, San Jose, CA (US); Wenguang Wang, Santa Clara, CA (US); Abhay Kumar Jain, Santa Clara, CA (US); Maxime Austruy, Pully (CH)

(21) Appl. No.: 18/465,896

(22) Filed: Sep. 12, 2023

(51) Int. Cl. G06F 16/17; G06F 16/18

(52) U.S. Cl. CPC G06F 16/1727; G06F 16/1805

(57) ABSTRACT

Workload-responsive segment cleaning of log structured filesystems (LFSs) is disclosed. When multiple independent LFSs overlap on spanning a set of storage disks (including non-volatile memory express storage), a global segment cleaner (GSC) for each disk coordinates the cleaning rates of the local segment cleaners (LSCs) for each LFS having a presence on that disk. LFSs send usage information to relevant GSCs that select usage thresholds to trigger cleaning and cleaning rates. When capacity fullness (e.g., segments having at least one used block) meets a threshold, segment cleaning is performed at a rate based on capacity fullness and an equilibrium cleaning rate. Cleaning rates speed up when storage is more full, to provide capacity for burst writing events, but slow down when less full, to reduce overhead burden. LFSs clean at the highest rate identified for every GSC's usage threshold an LFS meets.

### BACKGROUND

Objects such as virtual machines (VMs) may use log structured filesystems (LFSs) as storage solutions. LFSs perform new writes to contiguous log blocks (often at the end of a log), rather than over-writing old data in place. This means that old data that is still valid and old data that has been freed due to over-writes or deletions will be interspersed. It is often required to move the data that is still valid into a new, densely packed log block, called a segment, to reclaim space. This process is referred to as garbage collection or segment cleaning.

Each LFS has its own cleaner, and each LFS sees only its own write traffic and space consumption, rather than the total traffic and consumption of the storage disk. If multiple distinct LFSs running on distributed nodes in a cluster consume a shared pool of storage disks, from the perspective of one LFS, there may be no need to perform cleaning even though such cleaning would free up space for new writes arriving into a different LFS.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide for workload-responsive distributed segment cleaning of a log structured filesystem (LFS). Examples include: estimating an equilibrium cleaning rate for an LFS; determining a capacity fullness for the LFS, wherein the capacity fullness is based on at least a count of segments of the LFS having at least one used block; and based on at least the capacity fullness meeting a first capacity fullness threshold: setting a first cleaning rate based on at least the capacity fullness and the equilibrium cleaning rate; and performing segment cleaning of the LFS at the first cleaning rate.

Further examples include: collecting, by a first object, segment usage information of a first LFS used by the first object, the first LFS spanning a first plurality of storage disks, the segment usage information comprising a first segment usage metric; transmitting, by the first object, to a global segment cleaner (GSC) of each of the first plurality of storage disks, the first segment usage metric for the first LFS; receiving, by the first object, from a first GSC of a first storage disk of the first plurality of storage disks, a first target segment usage metric and a first target cleaning rate; and based on at least the first segment usage metric being no greater than the first target segment usage metric, performing, by the first object, segment cleaning of the first LFS at no less than the first target cleaning rate.

### BRIEF DESCRIPTION OF THE DRAWINGS

The present description will be better understood from the following detailed description read in the light of the accompanying drawings, wherein:

FIG. 1 illustrates an example architecture that advantageously provides for workload-responsive distributed segment cleaning of a log structured filesystem (LFS);

FIG. 2 illustrates further detail for an example of an architecture that may be used with or as part of the architecture of FIG. 1;

FIG. 3 illustrates further detail for another example architecture that may be used with or as part of the architecture of FIG. 1;

FIG. 4A illustrates an exemplary LFS, showing used and unused segments, prior to cleaning, as may be encountered in some examples of the architecture of FIG. 1;

FIG. 4B shows the exemplary LFS of FIG. 4A after segment cleaning;

FIG. 5 illustrates exemplary information used to set segment cleaning parameters in an example architecture, such as that of FIG. 1;

FIG. 6 illustrates exemplary segment cleaning parameters that may be used to control segment cleaning in an example architecture, such as that of FIG. 1;

FIG. 7 illustrates exemplary global segment cleaners (GSCs) that may be used in segment cleaning processes in an example architecture, such as that of FIG. 1;

FIG. 8 illustrates exemplary timelines of a segment cleaning process, as may occur in an example architecture, such as that of FIG. 1;

FIG. 9 illustrates disk balancing as may occur in an example architecture, such as that of FIG. 1;

FIG. 10 illustrates further detail for an object comprising sub-objects (concatenation legs), as may be encountered in an example architecture, such as that of FIG. 1;

FIGS. 11-14 illustrate examples of various flowcharts of exemplary operations associated with an example architecture, such as that of FIG. 1; and

FIG. 15 illustrates a block diagram of an example computing apparatus that may be used as a component of an example architecture such as that of FIG. 1.

Any of the figures may be combined into a single example or embodiment.

### DETAILED DESCRIPTION

Aspects of the disclosure provide for workload-responsive distributed segment cleaning of log structured filesystem (LFS) used by objects such as virtual machines (VMs) or other objects. When multiple independent LFSs overlap on spanning a set of storage disks (including non-volatile memory express, NVMe, storage and/or solid state disks, SSDs), a global segment cleaner (GSC) for each disk globally coordinates the cleaning rates of the local segment cleaners (LSCs) for each LFS having a presence on that disk. LFSs send segment usage information to relevant GSCs that select cleaning thresholds and rates.

When a capacity fullness (based on segments having at least one used block) meets a threshold, segment cleaning is performed at a rate that is a function of the capacity fullness and the equilibrium cleaning rate. The equilibrium cleaning rate is the segment cleaning rate that preserves a disk at some constant level of fullness. The primary goal of segment cleaning is to prevent a storage disk from running out of free segments to write into, while there is free space that is reclaimable by the segment cleaning process. As long as new writes continue to arrive at the storage disk, an equilibrium will eventually be reached, in which the net write rate equals the segment cleaning rate. The cleaning rate speeds up when storage is more full, to provide capacity for burst writing events, but slows down when less full, to reduce overhead burden. LFSs clean at the highest designated rate of every threshold that is met.

The GSCs monitor and manage the segment cleaning rate required for every storage disk. The GSCs have a protocol for communicating with the LSCs of all the objects using a storage disk to request a cleaning rate that is both efficient and sufficiently fast. The GSCs accomplish this by monitoring the disk fullness and net write rate, calculating the required cleaning rate to achieve equilibrium (e.g., the storage disk does not run out of space or perform unnecessary cleaning), monitoring the profile of how “good” (as defined herein) all objects on the disks' segments are, and communicating the cleaning requirements among a set of LSCs to provide sufficient parallelism while preferring the more efficient cleaning opportunities. To facilitate the GSCs' tasks, each LSC collects statistics about the distribution of fullness of the segments of its LFS and communicates those statistics to the relevant GSCs on some schedule.

Aspects of the disclosure improve the speed and reduce power usage of computing operations that use LFSs by improving the efficiency and responsiveness of LFS segment cleaning operations. This advantageous operation is achieved, at least in part, by providing a distributed protocol to coordinate when different LFSs using a common pool of storage disks start cleaning and which objects to clean, and how fast they each should perform cleaning, and/or by providing an intelligent cleaning rate selection scheme that balances cleaning needs with saving cleaning cycles when the workload permits.

Some examples proactively clean efficiently, moving the smallest amount of data that is practical, by finding the least full segments from among multiple objects sharing a common storage disk (e.g., objects having a presence on the storage disk). Some examples request segment cleaning from a sufficient number of objects, at an intelligently-selected cleaning rate, to achieve equilibrium and preventing the storage disk from filling up. A balance is struck between cleaning efficiently (e.g., avoiding unnecessary cleaning) and cleaning enough to avoid disk fullness, which are goals that are typically in opposition. The goal is to manage processes that reclaim usable space so that users experience consistent performance avoiding fluctuations or stalls, which occur when storage space becomes full. Aggressive segment cleaning opens up more space for burst writes, but risks inefficiency. Achieving an intelligent balance, as disclosed herein, ensures little to no performance impact at low cluster utilization and smooth, predictable changes as the cluster fills up.

Some examples set a cleaning rate based on at least an LFS capacity fullness and an equilibrium cleaning rate, and perform segment cleaning of the LFS at that cleaning rate. This scheme provides an intelligently-selected cleaning rate. In some examples, an object receives a target segment usage metric and a target cleaning rate from a GSC and, based on at least a segment usage metric of the object meeting the target segment usage metric, perform segment cleaning of the object's LFS at no less than the target cleaning rate. This scheme provides coordination among the different LFSs. Thus, because segment cleaning of LFSs is a technical problem in the field of computing, aspects of the disclosure provide a practical, useful result to solve this technical problem. Further, segment cleaning is an operation that improves the functioning of the underlying computing device (e.g., better storage management). As such, the examples described herein improve the functioning of a computing device.

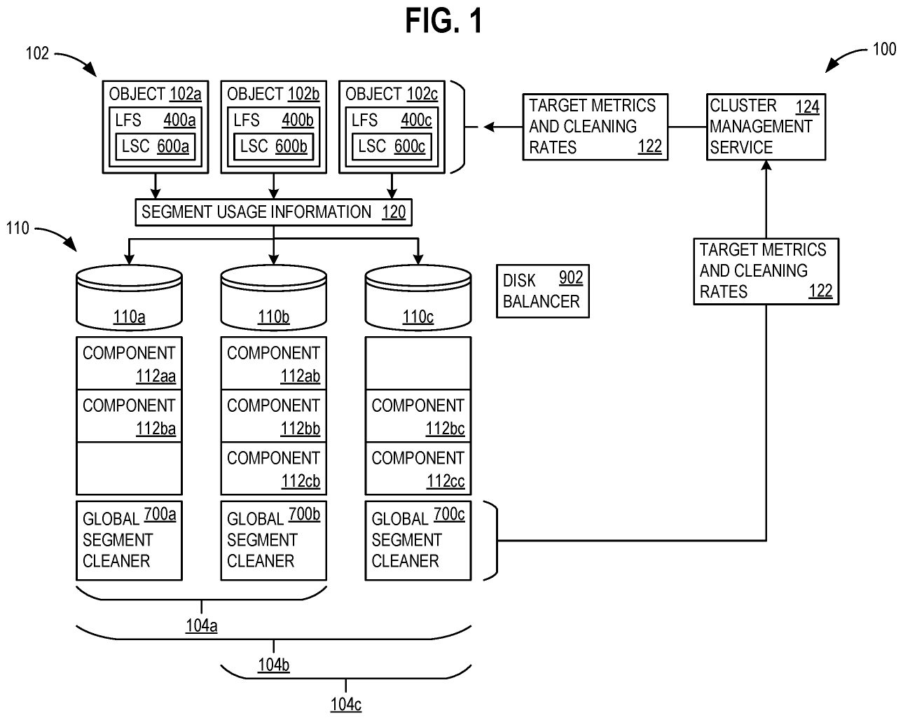

FIG. 1 illustrates an example architecture 100 that advantageously provides for workload-responsive distributed segment cleaning of an LFS. Architecture 100 is in the form of a cluster, in which a plurality of objects 102 overlaps their use of shared storage 110. Plurality of objects 102 includes an object 102a, an object 102b, and an object 102c, each of which may be a VM. Although only three objects are shown, it should be understood that some examples may use a larger number, such as thousands, tens of thousands, or more. Storage 110 has a pool of storage disks and is illustrated as including three storage disks, a storage disk 110a, a storage disk 110b, and a storage disk 110c, although it should be understood that a larger number may be used in some examples. Each of storage disks 110a-110c may be NVMe or SSD devices, or some other form of physical storage devices, and the term “disk” as used herein is not limited to spinning magnetic media. Storage 110 may use one or more redundant array of independent disks configurations, such as RAID-0, RAID-1, RAID-3, RAID-5, RAID-6, RAID-10, and others.

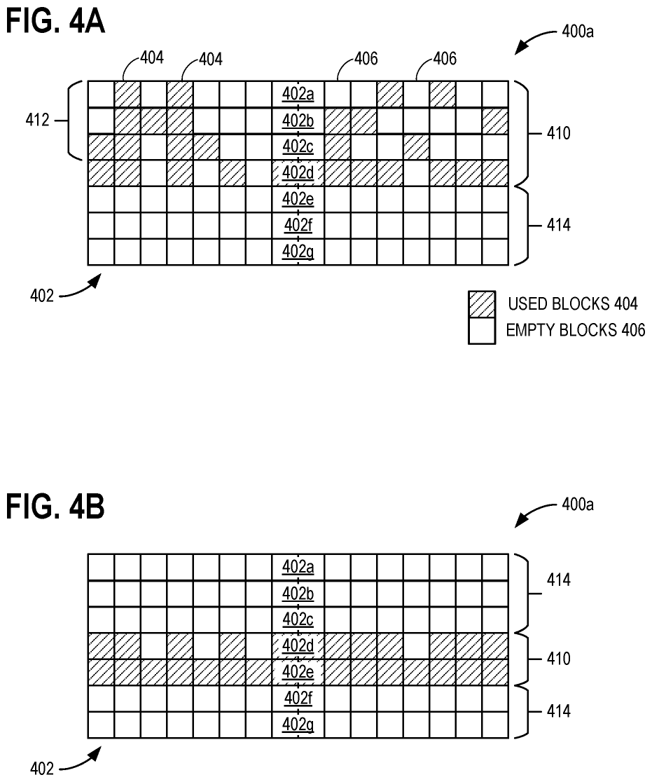

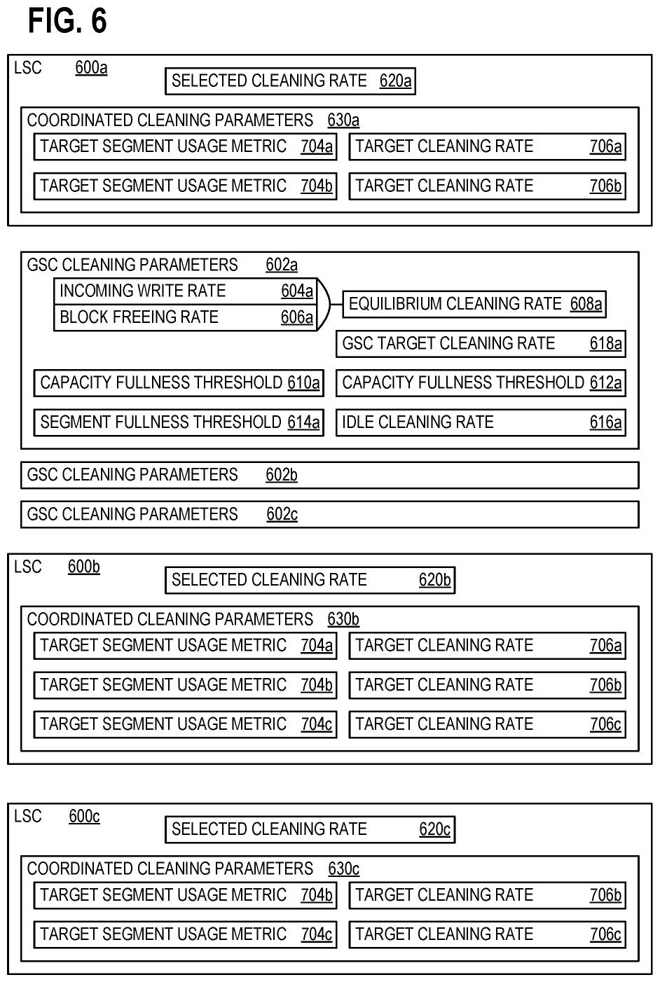

Each of objects 102a-102c is shown with its own LFS for persistent storage, although the locations of the LFSs may be outside of the objects themselves. For example, object 102a uses an LFS 400a, object 102b uses an LFS 400b, and object 102c uses an LFS 400c. In some examples, one or more of objects 102a-102c uses multiple LFSs, more than just a single LFS each. LFSs 400a-400c are shown and described in further detail in FIG. 4. LFSs 400a-400c run on distributed nodes in a cluster environment of architecture 100. Each of LFSs 400a-400c has its own LSC for segment cleaning. For example, LFS 400a has an LSC 600a, LFS 400b has an LSC 600b, and LFS 400c has an LSC 600c. LSCs 600a-600c are shown and described in further detail in FIG. 6. LSCs may also be referred to as segment cleaning managers (SCMs).

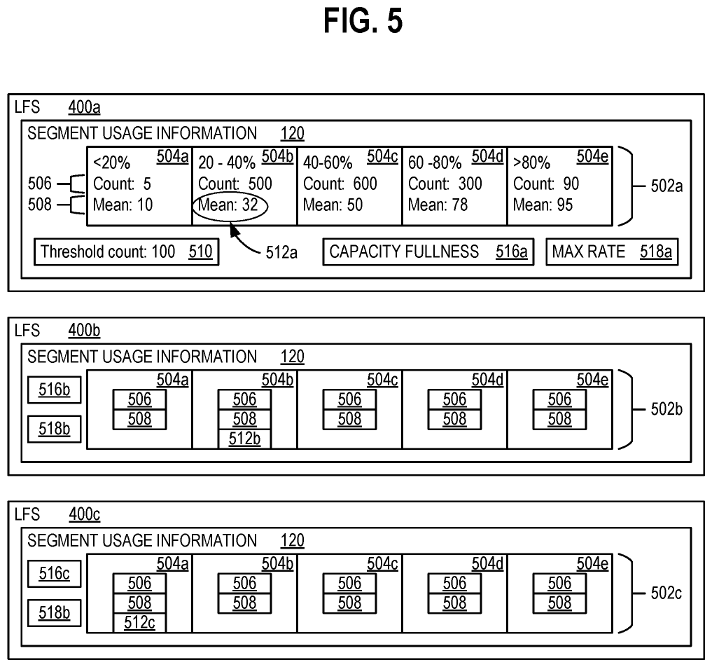

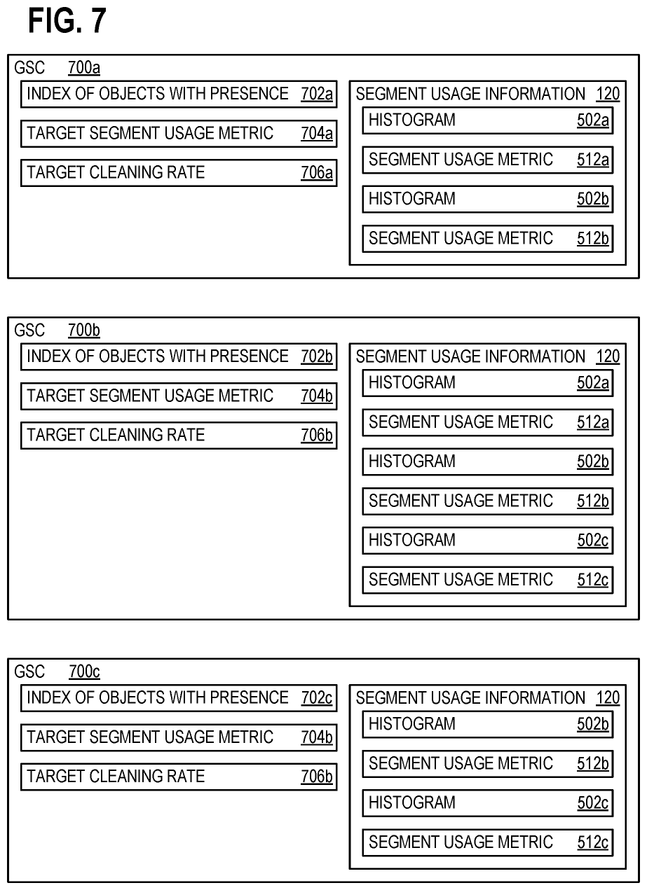

As described in further detail below, each of objects 102a-102c, possibly using its LFC or LSC (e.g., LFSs 400a-400c or LSCs 600a-600c), transmits segment usage information 120 to relevant GSCs in storage 110. Segment usage information 120 may be piggybacked on input/output (IO) signals from LFSs 400a-400c to storage 110, shown and described in further detail in FIG. 5. Each of storage disks 110a-110c has its own GSC, for example storage disk 110a has a GSC 700a, storage disk 110b has a GSC 700b, and storage disk 110c has a GSC 700c. GSCs 700a-700c are shown and described in further detail in FIG. 7. GSCs 700a-700c intercept segment usage information 120 and leverage segment usage information 120 to provide coordination among LSCs 600a-600c for distributed segment cleaning (or garbage collection) that is responsive to workloads of LFSs 400a-400c.

GSCs 700a-700c instruct the relevant ones of LSCs 600a-600c using target metrics and cleaning rates 122, which is transmitted through a cluster management service 124 back to LSCs 600a-600c. The ones of LSCs 600a-600c that are relevant to each of GSCs 700a-700c, and the ones of GSCs 700a-700c that are relevant to each of LSCs 600a-600c are determined by which of LFSs 400a-400c have a presence on each of storage disks 110a-110c. In some examples, each storage disk has only a single GSC, and each LFS has only a single LSC.

In the illustrated example, LFS 400a uses a plurality of storage disks 104a that includes storage disk 110a and storage disk 110b. LFS 400a has a component 112aa on storage disk 110a and a component 112ab on storage disk 110b. Component 112aa is a presence of LFS 400a on storage disk 110a and component 112ab is a presence of LFS 400a on storage disk 110b. LSC 600a thus sends segment usage information 120 (for LFS 400a) to GSC 700a of storage disk 110a and to GSC 700b of storage disk 110b. GSC 700a and GSC 700b each transmit their respective target metrics and cleaning rates 122 to LSC 600a.

LFS 400b uses a plurality of storage disks 104b that includes storage disk 110a, storage disk 110b, and storage disk 110c. Plurality of storage disks 104a and plurality of storage disks 104b overlap by storage disks 110a and 110b. LFS 400b has a component 112ba on storage disk 110a, a component 112bb on storage disk 110b, and a component 112bc on storage disk 110c. Component 112ba is a presence of LFS 400b on storage disk 110a, component 112bb is a presence of LFS 400b on storage disk 110b, and component 112bc is a presence of LFS 400b on storage disk 110c. LSC 600b thus sends segment usage information 120 (for LFS 400b) to GSC 700a of storage disk 110a, GSC 700b of storage disk 110b, and GSC 700c of storage disk 110c. GSC 700a, GSC 700b, and GSC 700c each transmit their respective target metrics and cleaning rates 122 to LSC 600b.

LFS 400c uses a plurality of storage disks 104c that includes storage disk 110b and storage disk 110c. Plurality of storage disks 104a and plurality of storage disks 104c overlap by storage disk 110b, while plurality of storage disks 104b and plurality of storage disks 104c overlap by storage disks 110b and 110c. LFS 400c has a component 112cb on storage disk 110b and a component 112cc on storage disk 110c. Component 112cb is a presence of LFS 400c on storage disk 110b and component 112cc is a presence of LFS 400c on storage disk 110c. LSC 600c thus sends segment usage information 120 (for LFS 400c) to GSC 700b of storage disk 110cb and GSC 700c of storage disk 110c. GSC 700b and GSC 700c each transmit their respective target metrics and cleaning rates 122 to LSC 600c.

In some examples, cluster management service 124 comprises a cluster monitoring, membership, and directory service (CMMDS) that handles the inventory of a storage area network, such as a virtual storage area network, including objects, hosts, disks, network interfaces, policies, names, and other items. Various components of architecture 100 may use cluster management service 124 as a central directory to publish updates about components, and information published into cluster management service 124 may be retrieved by other components.

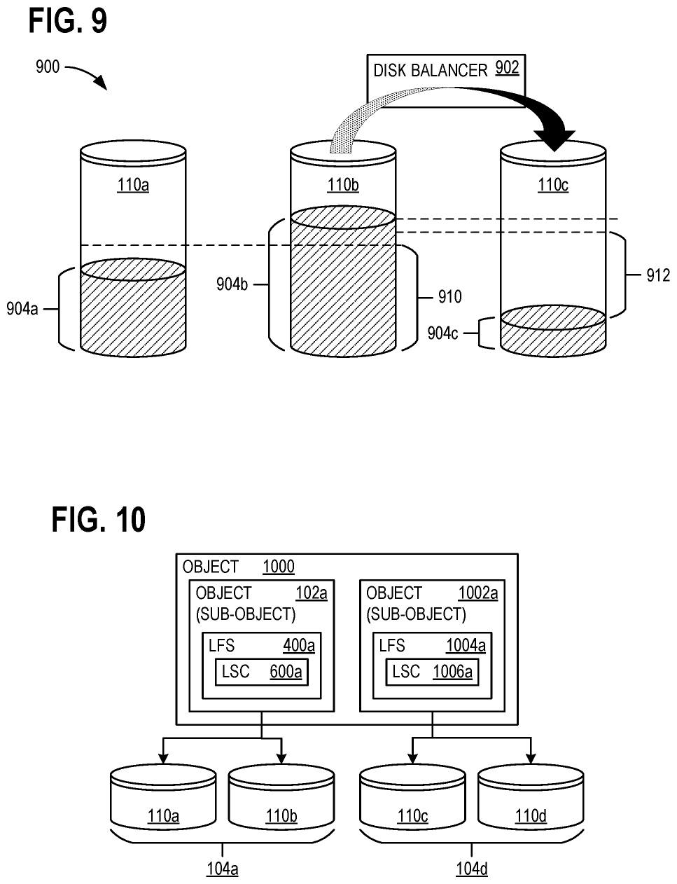

LSCs 600a-600c subscribe to updates from cluster management service 124, including target metrics and cleaning rates 122 of the relevant GSCs. Each of LSCs 600a-600c may receive target metrics and cleaning rates 122 from multiple ones of GSCs 700a-700c, since LFSs 400a-400c stripe their segment data across multiple storage disks. When one or more of the storage disks of storage 110 becomes significantly fuller than another, a disk balancer 902 performs rebalancing, to even out the storage load. This is shown and described in further detail in FIG. 9.

While some examples are described in the context of objects such as VMs, aspects of the disclosure are operable with any form of virtual computing instance (VCI). As used herein, a VCI is any isolated software entity that can run on a computer system, such as a software application, a software process, container, or a VM. Examples of architecture 100 are operable with virtualized and non-virtualized storage solutions. For example, any of objects 201-204, described below, may correspond to any of objects 102a-102c.

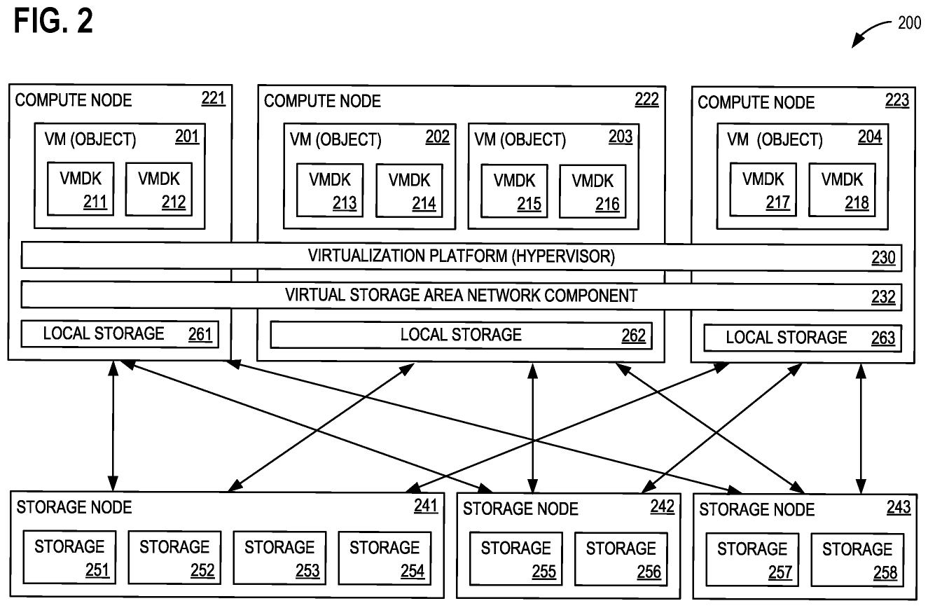

FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or VCI) that consumes storage. A VM includes, but is not limited to, a base object, linked clone, independent clone, and the like. A compute entity includes, but is not limited to, a computing instance, a VCI, and the like.

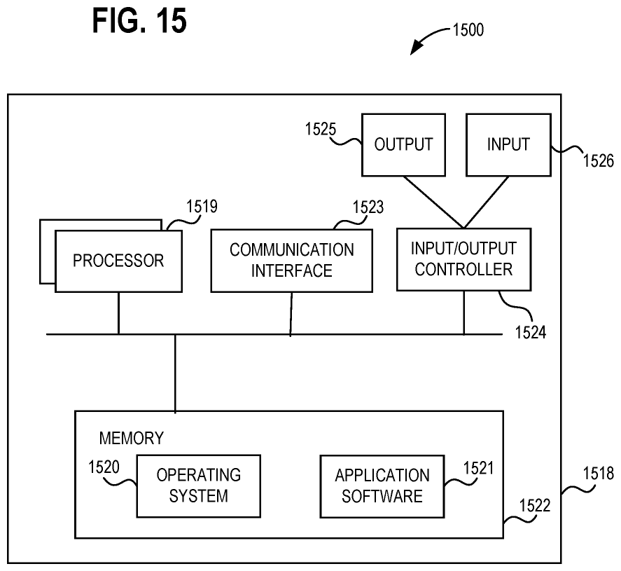

When objects are created, they may be designated as global or local, and the designation is stored in an attribute. For example, compute node 221 hosts object 201, compute node 222 hosts objects 202 and 203, and compute node 223 hosts object 204. Some of objects 201-204 may be local objects. In some examples, a single compute node may host 50, 100, or a different number of objects. Each object uses a VMDK, for example VMDKs 211-218 for each of objects 201-204, respectively. Other implementations using different formats are also possible. A virtualization platform 230, which includes hypervisor functionality at one or more of compute nodes 221, 222, and 223, manages objects 201-204. In some examples, various components of virtualization architecture 200, for example compute nodes 221, 222, and 223, and storage nodes 241, 242, and 243 are implemented using one or more computing apparatus such as computing apparatus 1518 of FIG. 15.

Virtualization software that provides software-defined storage (SDS), by pooling storage nodes across a cluster, creates a distributed, shared datastore, for example a SAN. Thus, objects 201-204 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 253, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-204 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201-204. Virtual SAN component 232 permits objects 201-204 to write incoming data from object 201-204 to storage nodes 241, 242, and/or 243, in part, by virtualizing the physical storage components of the storage nodes.

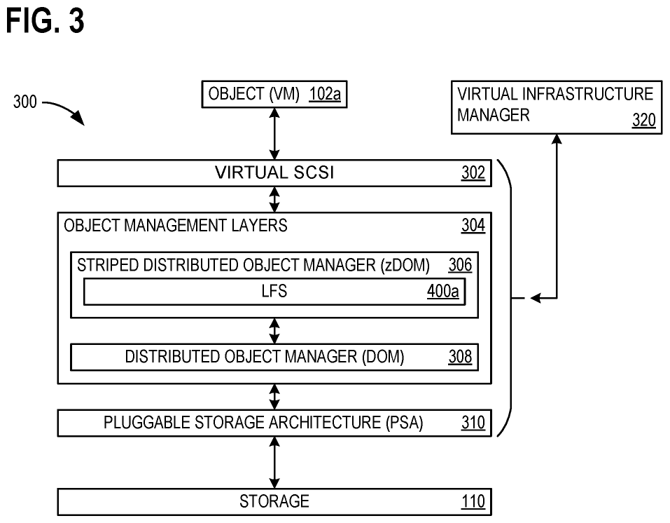

FIG. 3 illustrates an express storage architecture (ESA) 300 that may use the disclosure herein for cleaning LFSs. ESA 300 includes a virtual small computer systems interface (SCSI) 302, object management layers 304, a pluggable storage architecture (PSA) 310 and other virtual storage area network layers (not shown), as needed. In some examples, at least some of virtual SCSI 302, object management layers 304, and PSA 310 are implemented within a hypervisor, such as within virtualization platform 230. PSA 310 includes VM kernel APIs that allow third party hardware vendors to insert code directly into the input/output (IO) storage path, enabling ESA 300 to provide the interface between object 102a (and other objects 102b and 102c) and storage 110. In some examples, ESA 300 storage is managed by a virtual infrastructure manager 320 (e.g., VMware vCenter server) that provides a centralized and extensible platform for managing virtual infrastructure.

Object management layers 304 include a striped distributed object manager zDOM 306 and a distributed object manager (DOM) 308. LFS 400a is a translation layer in zDOM 306. zDOM 306 has a top-level guest-visible logical address space that uses logical block addresses (LBAs). LBAs are transformed via two maps (in some examples) to a physical address space using physical block addresses (PBAs) for DOM 308. It should be noted that the term PBA, as used for DOM 308, undergoes further address translation before reaching physical devices such as storage disks 110a-110c (which may actually be another layer of abstraction above physical devices, in some examples). For example, RAID-6 and local log structured object managers (LSOMs) perform address translation.

ESA 300 uses multiple different LFSs which consume space from the same underlying pool of capacity available in storage 110. Furthermore, each LFS may have its zDOM orchestrator code (the owner) executing on a different host in the cluster. A single zDOM object (e.g. LFS 400a) may touch multiple storage disks in the cluster, and a single storage disk in the cluster may store data for multiple zDOM objects in the cluster, giving an N-to-M mapping between LFSs and storage disks. Since the zDOM owners that manage data living on a given storage disk may be distributed across multiple different hosts in the cluster, a distributed protocol is disclosed herein to coordinate which LSC performs cleaning and at what cleaning rate.

In some examples, zDOM 306 is an LFS associated with a DOM owner. zDOM 306 writes data in units called segments, which are 512 kilobytes (kB) long, using units of 4 kb blocks as the smallest resolution unit, in some examples. A single segment may contain many IOs worth of data, because IOs may be smaller than 512 kB and so are batched into 512 kB chunks (or whatever size the segment is) for writing. As data is “erased”, such as by being logically deleted or over-written, the 4 kB blocks in the segment are marked as free. So, at some time after writing, some of the data may no longer be current, such as by having been deleted or replaced. These actions may be referred to as over-writes, and the rate at which they occur may be referred to as a freeing rate, because the affected 4 kB blocks of a segment are now free for being written again (without loss of the data that had been stored in those blocks previously). The freeing of blocks may occur in a fractured manner resulting in partially used segments with “holes”. But rather than these holes being filled with new writes, the partially used segments are skipped over and data is only written to fully open segments.

Since an LFS only writes to fully open (e.g., unused, completely free) segments, segments which have a mixture of some free blocks and some blocks that are still used by valid data are skipped over for writing and are not written to again until they become completely free (e.g., fully open, unused). Each LFS sees which segments it has and tracks the average fullness of these segments so that it knows which ones are emptier and hence more efficient to clean. In general, the goal of segment cleaning is to wait as long as reasonably possible before starting cleaning because it is possible that new over-writes will either completely free up segments, avoiding the need for cleaning entirely, or make them even sparser and hence reduce the amount of data that must be moved to free up an entire segment's worth of space. An LSC performs a segment cleaning process that reads used blocks from partially used segments (e.g., segments that have some used blocks, but also some free blocks), consolidates them, and writes the data out again as a new, complete segment to a previously unused (e.g., fully open, completely free) segment.

In some examples, within a storage disk, segments are written where they are needed and there is no limit (e.g., no constrained object space) apart from physical limitations of the storage disk itself. In some examples, this is accomplished by over-provisioning each object's segment address space. This treats the entire pool of segments as a global pool that can be shared seamlessly across objects. Segments are consumed as needed and released back to the pool by unmapping, as needed.

FIG. 4A illustrates further detail for LFS 400a. LFS 400a has a set of segments 402 shown as segments 402a-402g. Each of segments 402a-402g is shown with sixteen blocks, although it should be understood that, in some examples, LFS 400a may have a larger number of segments, numbering in the thousands. In some examples, each segment may have approximately 128 blocks (e.g., (512 kB)/(4 kB)=128) although some blocks may be used for metadata, leaving fewer than 128 blocks for data. Segment 402a has five used blocks 404 and eleven empty blocks 406, and so is less than 50% full. Segment 402b has ten used blocks 404 and six empty blocks 406; segment 402c has eleven used blocks 404 and five empty blocks 406; and segment 402d has eleven used blocks 404 and five empty blocks 406.

Segments 402a-402d are within a set of segments 410 of LFS 400a having at least one used block 404. Segment 402a-402c are also within a set of low usage segments 412 having a segment fullness below a segment fullness threshold 614a (shown in FIG. 6). Segments 402e-402g are within a set of unused segments 414 (e.g., empty segments) that are available for writing as complete segments when a writing pointer (not shown) of LFS 400a comes to any of them. An empty segment is a segment that has no data written to it, or all previously-written data has been marked in a segment usage table (SUT, not shown) as an empty block 406, due to an over-write.

To avoid running out of room, some partially free segments are selected for consolidation by combining used blocks 404 from one set of segments to write a smaller number of complete segments. This is referred to as segment cleaning, and FIG. 4B shows LFS 400a after segment cleaning.

Together, segments 402a, 402b, and 402c have 16 used blocks 404 (4+6+6=16), which is enough to completely fill an empty segment in the illustrations of FIGS. 4A and 4B that show 16 blocks per segment (rather than the 128 blocks in some examples). The used blocks 404 of the three segments 402a, 402b, and 402c are read and rewritten to segment 402e. All blocks of segments 402a, 402b, and 402c are marked as empty blocks 406. In some examples, preference for cleaning is given to segments within a set of low usage segments 412.

After cleaning, segment 402d and segment 402e are within set of segments 410 of LFS 400a having at least one used block 404. Segments 402a, 402b, 402c, 402f, and 402g are within set of unused segments 414 that are available for writing, and may be written to when the writing pointer of LFS 400a comes around to any of them again.

Another unique scenario is depicted in FIG. 4B. As will be explained in further detail below, in some scenarios, there are two classes of cleaning rates. A relatively slow idle cleaning rate 616a, which is used during periods of low net writing (e.g., the incoming IOs drop to some low rate), and a faster cleaning rate that is based on an equilibrium cleaning rate (described in further detail in relation to FIG. 6). In some examples, during periods of the idle cleaning rate 616a, low usage segments 412 such as segment 402a are cleaned and high usage segments are not cleaned. High usage segments are those segments that are within set of segments 410 of LFS 400a having at least one used block 404, but not within set of low usage segments 412). However, during periods in which an equilibrium-based cleaning rate is used, both low usage segments 412 and high usage segments are cleaned, with preference being given to low usage segments 412, in some examples. In some examples, idle cleaning rate 616a is proportional to (or approximately so) the fullness of the segments.

In some examples, there is another aspect of selecting or prioritizing segments. In some scenarios, there are competing approaches. In one approach, prioritizing the segments with the highest amount of free space (e.g., fewest count of used blocks 404) frees up the largest number of segments for each new segment written. This is efficient, because the cost of cleaning is lower relative to the space reclaimed.

Another approach is to prioritize the segments with the oldest data. In some situations, relatively old data, which has not been erased, is likely to remain intact because it is stable. So, a partially free segment that has old data, but not much free space, is likely to remain in that condition for a significant length of time. Without cleaning such segments, the number of segments in this condition is likely to grow. So, partially free segments with older data should also have some priority for cleaning.

Some examples define a “goodness” of segments as:

$$goodness = \frac{( 1 - segment\_fullness ) \times age}{( 1 + segment\_fullness )} \qquad Eq . ( 1 )$$

where segment_fullness is a measure of the number of used blocks 404 in a segment, and age is a measure of how long ago the segment was written (e.g., since all blocks within the segment had been written at the same time). The quantity (1-segment_fullness) is a measure of free space in a segment. This balanced approach of using segment goodness, as opposed to using purely the amount of free space or the age, is employed in some examples.

Some examples aim to avoid substantially impacting IO performance keeping segment cleaning performance to less than 10% of the bandwidth overhead, while preventing latency spikes, due to running out of free segments for writing. Examples attempt to avoid wasting effort on cleaning segments that are not efficient to clean (e.g., mostly full) unless needed to reclaim critical space. Idle periods are taken advantage of to open up space for burst writes. Segment cleaning may be run on only LFSs having a sufficient goodness of segments, and segment cleanings are per storage disk, in some examples, rather than per object.

FIG. 5 illustrates exemplary information used to set segment cleaning parameters. LFS 400a has segment usage information 120, which includes a histogram 502a of segment fullness values for LFS 400a. The segment fullness values used to construct histogram 502a are the segment_fullness values also used in Eq. (1) above. Histogram 502a has bins 504a-504e that have counts of the number of segments whose segment fullness is within the histogram bin's band. In some examples, segment usage information 120 also includes an advertised maximum segment cleaning rate capability (e.g., 100 megabytes (MB) of segments with goodness X) as maximum cleaning rate 518a. This advertised segment cleaning rate capability is low enough to avoid adversely impacting IO, which could impact user experience.

As illustrated, bin 504a has a count 506 of the number of segments of LFS 400a that are between 0% full (completely empty) and 20% full. Count 506 is shown as five. bin 504b has a count 506 of the number of segments of LFS 400a that are between 20% (completely empty) and 40% full, shown as 500; bin 504c has a count 506 of the number of segments of LFS 400a that are between 40% full and 60% full, shown as 600; bin 504d has a count 506 of the number of segments of LFS 400a that are between 60% full and 80% full, shown as 300; and bin 504c has a count 506 of the number of segments of LFS 400a that are above 80% full, shown as 90.

Segment usage information 120 also includes an average (e.g., mean) of the segment fullness values of the segments included in a particular bin, which indicates skewness within each bin, and may be given in percentages. For example, bin 504a has an average segment fullness metric 508 (shown as a mean) of 10, which indicates no skew because the mean is at the center of bin 504a (e.g., 10% is the center of 0%-20%). Bin 504b has an average segment fullness metric 508 of 32, which is a slight skew to the high side of bin 504b; bin 504c has an average segment fullness metric 508 of 50, which is no skew; bin 504d has an average segment fullness metric 508 of 78, which is a skew to the low side of bin 504d; and bin 504e has an average segment fullness metric 508 of 95, which is a skew to the high side of bin 504e. In some examples, one of the average segment fullness metric 508 values is selected as a representative segment usage metric for the LFS. In the illustrated example, average segment fullness metric 508 of bin 504b is selected as segment usage metric 512a for LFS 400a.

In some examples, the selection criteria for segment usage metric 512a is the average segment fullness metric 508 of the lowest histogram bin having a count 506 that meets or exceeds a threshold count 510 of segment fullness values. In the illustrated example, bin 504a is lower than bin 504b, but has a count 506 of only five, which is below the value of 100 for threshold count 510 of segment fullness values. The reason for using threshold count 510 of segment fullness values is that segment usage metric 512a represents statistical information for LFS 400a, and the use of the threshold avoids basing the representation on a histogram bin that has too few segments. In some examples, segment usage metric 512a is based on the goodness metric of Eq. (1), rather than a mean of segment fullness values of the segments in a bin.

A capacity fullness 516a is a metric indicating how full LFS 400a is, independently of how the used blocks 404 are distributed among segments 402. That is, capacity fullness 516a is based on a count of used blocks 404 in LFS 400a, rather than number of segments 410 of LFS 400a having at least one used block 404.

LFS 400b and LFS 400c each also have their own version of segment usage information 120. Segment usage information 120 of LFS 400b has a histogram 502b of segment fullness values for LFS 400b, a segment usage metric 512b, a capacity fullness 516b, and a maximum cleaning rate 518b. Segment usage information 120 of LFS 400c has a histogram 502c of segment fullness values for LFS 400c, a segment usage metric 512c, a capacity fullness 516c, and a maximum cleaning rate 518b. In some examples, segment usage information 120 for each of LFSs 400a-400c piggybacks on the DOM owner to DOM component operation protocol, and is intercepted by the relevant one of GSCs 700a-700c. In some examples, GSCs 700a-700c are on the DOM component manager side, and LSCs 600a-600c operate in zDOM 306.

FIG. 6 illustrates exemplary segment cleaning parameters that may be used to control segment cleaning. Segment cleaning may be performed with global cleaning rates that span the multiple LFSs in a cluster and/or with local rates, as determined by a solo LFS. The description for FIG. 6 is provided in the context of global cleaning rates that are determined by GSCs. However, in some scenarios, a solo LFS determines its selected cleaning rate (e.g., LSC 600a determining selected cleaning rate 620a) based, at least partially, on its determined equilibrium cleaning rate (just that LFS's own writing and segment freeing rates). In some scenarios, this may be determined in a manner somewhat similar to that described below for a GSC determining its target cleaning rate based on capacity fullness (e.g., GSC 700a determining GSC target cleaning rate 618a or idle cleaning rate 616a).

In some examples, the LSC uses a first solo cleaning rate (which may be based at least partially on its determined equilibrium cleaning rate) as the selected cleaning rate when the segment fullness or capacity fullness is above a first threshold (e.g., 85%), and uses a second solo cleaning rate (which may also be based at least partially on its determined equilibrium cleaning rate) as the selected cleaning rate when the segment fullness or capacity fullness is above a second threshold (e.g., 95%). For solo cleaning, however, the allocation of a GSC cleaning rate among multiple LSCs, described below, is not needed in some examples.

GSC 700a determines GSC cleaning parameters 602a and described below, and LSC 600a receives coordinated cleaning parameters 630a from the relevant GSCs (in this case, GSC 700a and 700b). LSC 600a performs cleaning at a selected cleaning rate 620a to ensure that disks 110a and 110b do not run out of space. Coordinated cleaning parameters 630a are used to ensure that LSC 600a performs segment cleaning when it is required in a global context for the cluster that includes LFSs 400b and 400c, even when GSC cleaning parameters 602a may indicate that segment cleaning is not needed.

GSC cleaning parameters 602a include an incoming write rate 604a, which is the rate of segments written by incoming IOs to disk 110a, and a segment freeing rate 606a. Segment freeing rate 606a is a rate of segments being freed by unmap or over-write events. Subtracting segment freeing rate 606a from incoming write rate 604a gives a net write rate. Equilibrium cleaning rate 608a is the rate at which segments should be cleaned so that the number of segments having at least one used block 404 does not grow to completely fill disk 110a, leaving no room for new writes. At equilibrium cleaning rate 608a, one segment is freed for every new segment written from incoming IOs (as opposed to writes from consolidation).

A capacity fullness threshold 610a, which may be set at 80% in some examples, is used to determine when GSC target cleaning rate 618a should be set to a rate based on equilibrium cleaning rate 608a. In some examples, a piecewise linear equation is used, in which GSC target cleaning rate 618a is 50% of equilibrium cleaning rate 608a when capacity fullness 516a is 80% (e.g., meeting capacity fullness threshold 610a), growing linearly with capacity fullness 516a up to 100% of equilibrium cleaning rate 608a when capacity fullness 516a is 85%, and then growing linearly with capacity fullness 516a up to 200% of equilibrium cleaning rate 608a when capacity fullness 516a is 90%.

Another capacity fullness threshold 612a, which may be set at 50% in some examples, is used to determine when segment cleaning is performed at all. When capacity fullness 516a is below capacity fullness threshold 612a, GSC cleaning parameters 602a indicate that no segment cleaning is required. Segment fullness threshold 614a, which may be set at 50% in some examples, is used to select which segments are cleaned when idle cleaning rate 616a is used. During periods when idle cleaning rate 616a is used, segments having a segment fullness below segment fullness threshold 614a are not cleaned. See FIG. 4B for an example of this occurrence.

This scheme cleans quickly enough to ensure that there are sufficient completely free segments for burst writing events, but avoids wasting processing resources when cleaning is not necessary, because some blocks may be freed naturally by over-writes that occur during normal data operations. The longer cleaning is delayed, the more free space occurs naturally by over-writes.

As described thus far, GSC cleaning parameters 602a allow for the following scheme: When capacity fullness 516a is below capacity fullness threshold 612a, there is no segment cleaning. When capacity fullness 516a is above capacity fullness threshold 612a, but below capacity fullness threshold 610a, idle cleaning may occur at idle cleaning rate 616a, and GSC target cleaning rate 618a is set to idle cleaning rate 616a. However, segments which have a segment fullness below segment fullness threshold 614a are not cleaned; only segments which have a segment fullness above segment fullness threshold 614a are cleaned during idle cleaning.

When capacity fullness 516a is above capacity fullness threshold 610a, there is equilibrium based cleaning in which GSC target cleaning rate 618a is set as a function of capacity fullness 516a and equilibrium cleaning rate 608a. GSC target cleaning rate 618a increases (e.g., ramps up) as capacity fullness 516a increases above capacity fullness threshold 610a, to clean faster as LFS 400a nears its maximum capacity, but relaxes (e.g., ramps down) when more free segments appear in LFS 400a. In some examples, GSC target cleaning rate 618a accelerates when capacity fullness 516a goes significantly above capacity fullness threshold.

GSC target cleaning rate 618a is divided by the number of LSCs that GSC 700a determines (as described below) are needed to perform cleaning, and sent to each relevant LSC as target cleaning rate 706a. LSC 600a receives a target segment usage metric 704a and target cleaning rate 706a from GSC 700a. LSC 600a also receives a target segment usage metric 704b and a target cleaning rate 706b from GSC 700b. How GSCs 700a-700c set their target segment usage metrics 704a-700c and target cleaning rates 706a-706c is further described in relation to FIG. 7.

Coordinated cleaning parameters 630a are the result of LSC 600a spanning multiple disks and receiving cleaning instructions from multiple GSCs (e.g., GSC 600a and 600b). Selected cleaning rate 620a is the higher of the cleaning rates indicated by target cleaning rates 706a and 706b. If segment usage metric 512a for LFS 400a is at or below (no greater than) target segment usage metric 704a, LFS 400a meets the criteria to begin cleaning, as identified by GSC 700a. If segment usage metric 512a for LFS 400a is no greater than target segment usage metric 704b, LFS 400a meets the criteria to begin cleaning, as identified by GSC 700b. So, if segment usage metric 512a for LFS 400a is no greater than the lowest of target segment usage metrics 704a and 704b, coordinated cleaning parameters 630a indicate that LSC 600a should begin segment cleaning of LFS 400a. LSC 600a will use the greater of target cleaning rates 706a and 706b.

GSC 700b determines GSC cleaning parameters 602b and GSC 700c determines GSC cleaning parameters 602c similarly as described above for GSC 700a determining GSC cleaning parameters 602a. GSC 700b and GSC 700c each divide their own GSC target cleaning rates by the number of LSCs determined as needed to perform cleaning, producing target cleaning rates 708b and 708c for GSCs 700b and 700c, respectively. GSC cleaning parameters 602a-602c are updated on an ongoing basis.

LSC 600b has coordinated cleaning parameters 630b, which includes target segment usage metric 704a and target cleaning rate 706a received from GSC 700a, target segment usage metric 704b and target cleaning rate 706b received from GSC 700b, and a target segment usage metric 704c and target cleaning rate 706c from GSC 700c. If segment usage metric 512b for LFS 400b is no greater than the highest of target segment usage metrics 704a-704c, coordinated cleaning parameters 630b indicate that LSC 600b should begin segment cleaning of LFS 400b, using the greater of target cleaning rates 706a-706c. Selected cleaning rate 620b is the highest of the cleaning rates indicated by target cleaning rates 706a-706c.

LSC 600c has coordinated cleaning parameters 630c, which includes target segment usage metric 704b and target cleaning rate 706b received from GSC 700b, and target segment usage metric 704c and target cleaning rate 706c from GSC 700c. If segment usage metric 512c for LFS 400c is no greater than the highest of target segment usage metrics 704b or 704c, coordinated cleaning parameters 630c indicate that LSC 600b should begin segment cleaning of LFS 400c, using the greater of target cleaning rates 706b or 706c. Selected cleaning rate 620c is the highest of the cleaning rates indicated by target cleaning rates 706b and 706c.

FIG. 7 illustrates further detail for GSCs 700a-700c. GSC 700a maintains an index 702a of objects with a presence on storage disk 110a. In some examples, index 702a is a sorted tree, such as a red-black tree, although other data structures may be used. When conditions of storage disk 110a warrant segment cleaning, GSC 700a determines target segment usage metric 704a. In some examples, GSC 700a determines target segment usage metric 704a by starting with a low candidate value and progressively increasing while tracking the number of LSCs meeting the candidate value. This number may be determined using maximum cleaning rates 518a and 518b, histogram 502a of segment fullness values for LFS 400a, segment usage metric 512a, histogram 502b of segment fullness values for LFS 400b, and segment usage metric 512b.

The number of LSCs needed to perform cleaning should not be too low, because a small set of LSCs may not be able to keep up with the needed rate of cleaning. Each LSC can only clean as some maximum rate, yet storage disk 110a is being written to by multiple LFSs. The number of LSCs should also not be too high, because that results in wasting resources on unnecessary cleaning. Thus, the candidate value is set such that the minimum number of LCSs that can meet the cleaning demand for storage disk 110a will begin cleaning. In the illustrated example, if only one of LSCs 600a and 600b is needed for cleaning, target segment usage metric 704a is set at the lowest of segment usage metrics 512a and 512b. However, if both of LSCs 600a and 600b are needed for cleaning, target segment usage metric 704a is set at the highest of segment usage metrics 512a and 512b. Target cleaning rate 706a is then GSC target cleaning rate 618a for storage disk 110a divided by the number of LSCs (e.g., the number of objects, in this example up to two) that GSC 700a has determined should perform a segment cleaning process.

GSC 700b similarly maintains an index 702b of objects with a presence on storage disk 110b. GSC 700b determines target segment usage metric 704b using maximum cleaning rates 518a-518c, histogram 502a of segment fullness values for LFS 400a, segment usage metric 512a, histogram 502b of segment fullness values for LFS 400b, maximum cleaning rates 518b and 518c, histogram 502c of segment fullness values for LFS 400c, and segment usage metric 512c. However, in this illustrated example, GSC 700b is able to select from up to three LSCs for cleaning. Target cleaning rate 706b is GSC target cleaning rate 618b for storage disk 110b divided by the number of LSCs (in this case, up to three) that GSC 700b has determined should perform a segment cleaning process.

GSC 700c similarly maintains an index 702c of objects with a presence on storage disk 110c. GSC 700c determines target segment usage metric 704c using segment usage information 120, including histogram 502b of segment fullness values for LFS 400b, segment usage metric 512b, histogram 502c of segment fullness values for LFS 400c, and segment usage metric 512c. In this illustrated example, GSC 700c is able to select from up to two LSCs for cleaning. Target cleaning rate 706c is GSC target cleaning rate 618c for storage disk 110c divided by the number of LSCs (in this case, up to two) that GSC 700c has determined should perform a segment cleaning process.

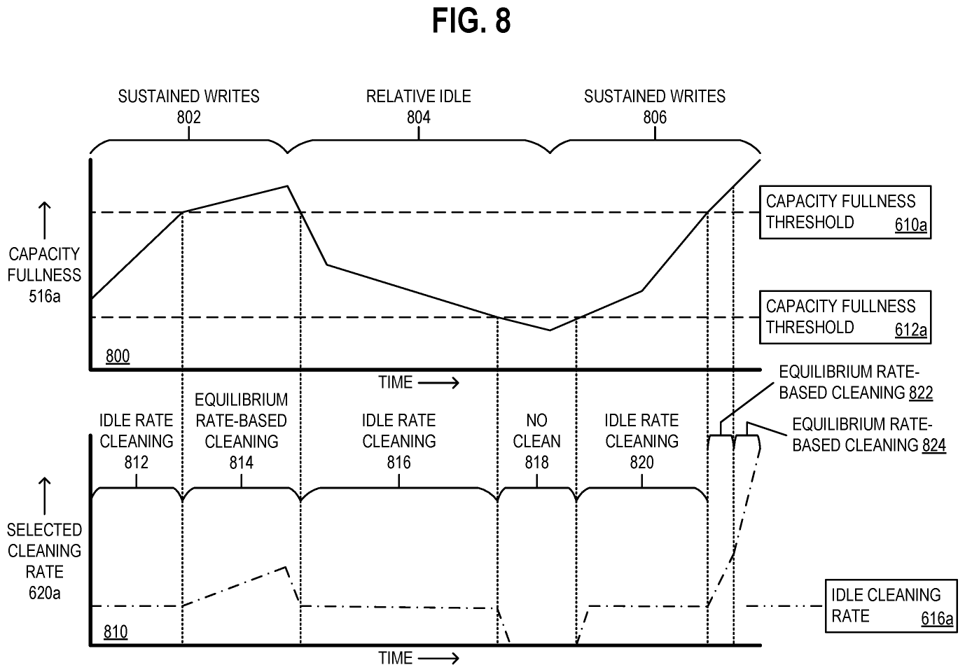

FIG. 8 illustrates an exemplary timeline 800, plotting capacity fullness 516a against time, and a synchronized timeline 810, plotting selected cleaning rate 620a against time. A set of time periods is shown. A time period 802 has sustained writes; a time period 804 is a relative idle, with few or no incoming writes; and a time period 806 has sustained writes, similarly to time period 802.

During a time period 812, which is within time period 802, capacity fullness 516a increases from a value above capacity fullness threshold 612a to capacity fullness threshold 610a. Because capacity fullness 516a is above capacity fullness threshold 612a but below capacity fullness threshold 610a, selected cleaning rate 620a is set to idle cleaning rate 616a. During a time period 814, which is mostly within time period 802, capacity fullness 516a increases above capacity fullness threshold 610a, and selected cleaning rate 620a increases proportionally to (e.g., piecewise linearly) capacity fullness 516a until capacity fullness 516a begins to fall. Selected cleaning rate 620a then falls along with capacity fullness 516a.

During a time period 816, which is within time period 804, capacity fullness 516a drops below capacity fullness threshold 610a down to capacity fullness threshold 612a, and selected cleaning rate 620a is set to idle cleaning rate 616a. During a time period 818, which is mostly within time period 804, capacity fullness 516a drops below capacity fullness threshold 612a and segment cleaning is suspended as selected cleaning rate 620a is set to zero. However, sustained writes resume in time period 806, and capacity fullness 516a begins to climb. Time period 818 ends and selected cleaning rate 620a is set to idle cleaning rate 616a as capacity fullness 516a climbs above capacity fullness threshold 612a in time period 820.

When capacity fullness 516a climbs above capacity fullness threshold 610a, selected cleaning rate 620a returns to being proportional to capacity fullness 516a, in a time period 822. However, as capacity fullness 516a climbs even further above capacity fullness threshold 610a, the proportionality of selected cleaning rate 620a to capacity fullness 516a becomes even steeper in a time period 824. This tracks the prior example described, in which selected cleaning rate 620a ranges from 50% to 100% of equilibrium cleaning rate 608a as capacity fullness 516a ranges from 80% to 85%, whereas selected cleaning rate 620a ranges from 100% to 200% of equilibrium cleaning rate 608a as capacity fullness 516a ranges from 85% to 90%.

In some examples, the transition between cleaning rates is smoothed, so that a plot of selected cleaning rate 620a traces a smooth curve over time, rather than manifesting abrupt changes. This prevents noticeable performance changes for users of architecture 100.

FIG. 9 illustrates a disk balancing scenario 900. In scenario 900, storage disk 110b is noticeable fuller than storage disk 110c. Disk balancer 902 tracks raw usage of each of storage disks 110a-110c. Storage disk 110a has a raw usage 904a, storage disk 110b has a raw usage 904b, and storage disk 110c has a raw usage 904c. A rebalancing threshold 910 is used to determine when rebalancing may be necessary for a disk, and may be set at 70% or 80% of raw usage (also called capacity fullness) in some examples. Raw usage may be determined the way capacity fullness is determined, by the number or percentage of blocks (e.g., 4 kB blocks) of a storage disk that are used blocks 404. In some examples, however, raw usage or capacity may be measured in percentage, whereas the other is measured in absolute count of used blocks 404, or both may have identical definitions.

As illustrated, raw usage 904b is above rebalancing threshold 910. The next question is whether there is another suitable storage disk to which disk balancer 902 may move data. Storage disk 110c has a relatively low raw usage 904c, and it is so low that the difference between raw usage 904b and raw usage 904c exceeds another rebalancing threshold 912. So, disk balancer 902 moves data from storage disk 110b to storage disk 110c. In some examples, only data within an LFS that already had at least some data on storage disk 110c will be moved to storage disk 110c. In such examples, because LFS 400a was not already using storage disk 110c, but LFSs 400b and 400c were already using storage disk 110c, disk balancer moves data from LFSs 400b and 400c from storage disk 110b to storage disk 110c, but does not move any data from LFS 400a.

FIG. 10 illustrates further detail for an object 1000 comprising sub-objects (e.g., concatenation legs). Object 1000 has two sub-objects, object 102a and another object 1002a. Object 1002a uses an LFS 1004a, with an LSC 1006a. Object 102a uses plurality of storage disks 104a that includes storage disk 110a and storage disk 110b, whereas object 1002a uses a plurality of storage disks 104d that includes storage disk 110c and a storage disk 110d. What has been described thus far for object 102a is valid whether object 102a is a sub-object or a stand-alone object (e.g., not a sub-object or concatenation leg).

A sub-object may also be referred to as a concatenation leg. The situation depicted in FIG. 10 may arise when a given zDOM object has different raid stripe configurations, each of which touches a different set of disks. This results in a set of concatenation legs (e.g., sub-objects), and data is distributed across the multiple concatenation legs. Within each concatenation leg, the data is striped evenly across all associated disks. For example, a large object may have five concatenation legs, each of which distributes data evenly across six disks (for 4+2 for RAID-6 striping).

Depending on whether disks are reused across multiple concatenation legs, the top object may use anywhere between six and thirty disks. Since each concatenation leg has its own set of segments and its own statistics, each concatenation leg has a separate LSC that functions independently of the other concatenation legs' LSCs. Thus, each concatenation leg behaves as an independent object, as described above for objects 102a-102c.

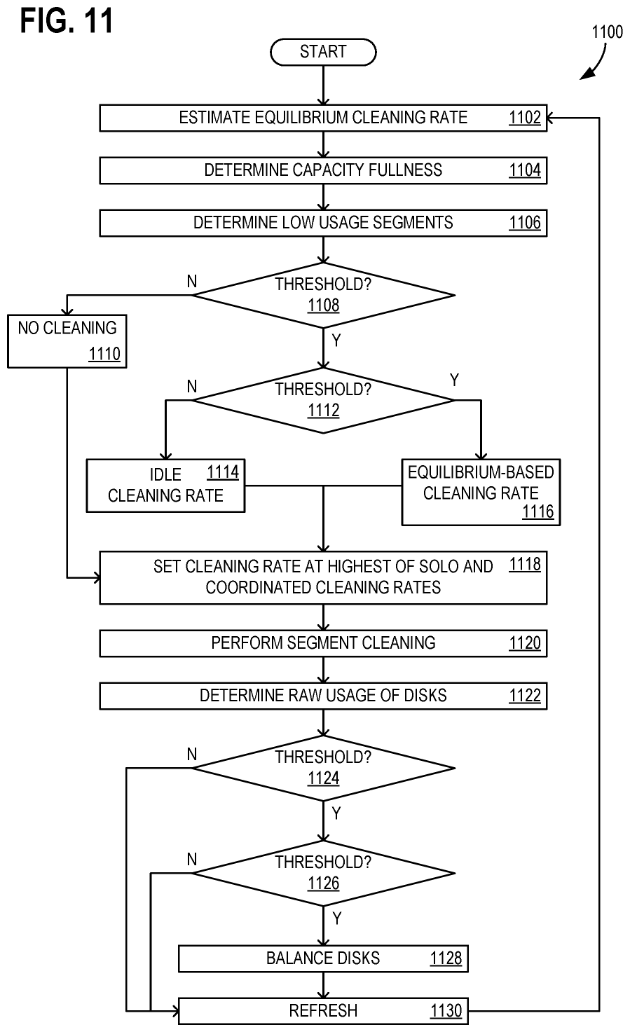

FIG. 11 illustrates a flowchart 1100 of exemplary operations that may be performed by examples of architecture 100. In some examples, the operations of flowchart 1100 are performed by one or more computing apparatus 1518 of FIG. 15. Flowchart 1100 is described for object 102a, although it should be understood that equivalent versions of flowchart 1100 are running in parallel for each of the other objects 102b and 102c.

Flowchart 1100 commences with LSC 600a estimating equilibrium cleaning rate 608a for LFS 400a in operation 1102. Operation 1104 determines capacity fullness 516a for LFS 400a, based on at least a count of segments of LFS 400a having at least one used block 404. In operation 1106, LSC 600a determines a set of low usage segments 412 having a segment fullness below segment fullness threshold 614a.

Decision operation 1108 determines whether capacity fullness 516a meets capacity fullness threshold 612a. If not, operation 1110 sets selected cleaning rate 620a to zero and LSC 600a does not perform segment cleaning. Flowchart 1100 then moves to operation 1118, which is described below. Otherwise, if capacity fullness 516a meets capacity fullness threshold 612a, decision operation 1112 determines whether capacity fullness 516a meets capacity fullness threshold 610a. If not, operation 1114 sets selected cleaning rate 620a to idle cleaning rate 616a and performs segment cleaning of segments in LFS 400a that are not within the set of low usage segments 412. Flowchart 1100 then moves to operation 1118.

Otherwise, operation 1116 sets selected cleaning rate 620a based on at least capacity fullness 516a and equilibrium cleaning rate 608a. In some examples, operation 1118 sets selected cleaning rate 620a as the higher cleaning rate indicated by GSC cleaning parameters 630a and coordinated cleaning parameters 630a, and operation 1120 performs segment cleaning of the LFS at selected cleaning rate 620a, if it hadn't been performed in either of operations 1114 or 1116.

In operation 1122, disk balancer 902 determines raw usage 904a of storage disk 110a, and raw usage 904b of storage disk 110b. Decision operation 1124 determines whether raw usage 904a exceeds rebalancing threshold 910, and if so, decision operation 1126 determines whether raw usage 904a exceeds raw usage 904b by at least rebalancing threshold 912. If both conditions are not met (either fails), flowchart 1100 moves to operation 1130, described below. If, however, both conditions are met, disk balancer 902 moves data from storage disk 110a to storage disk 110b in operation 1128

Operation 1130 performs a refresh on some trigger, such as a schedule or certain storage disk statistics conditions, and flowchart 1100 returns to operation 1102 to determine equilibrium cleaning rate 608a. Equilibrium cleaning rate 608a may change, due to IO changing (e.g., incoming writes increasing or decreasing).

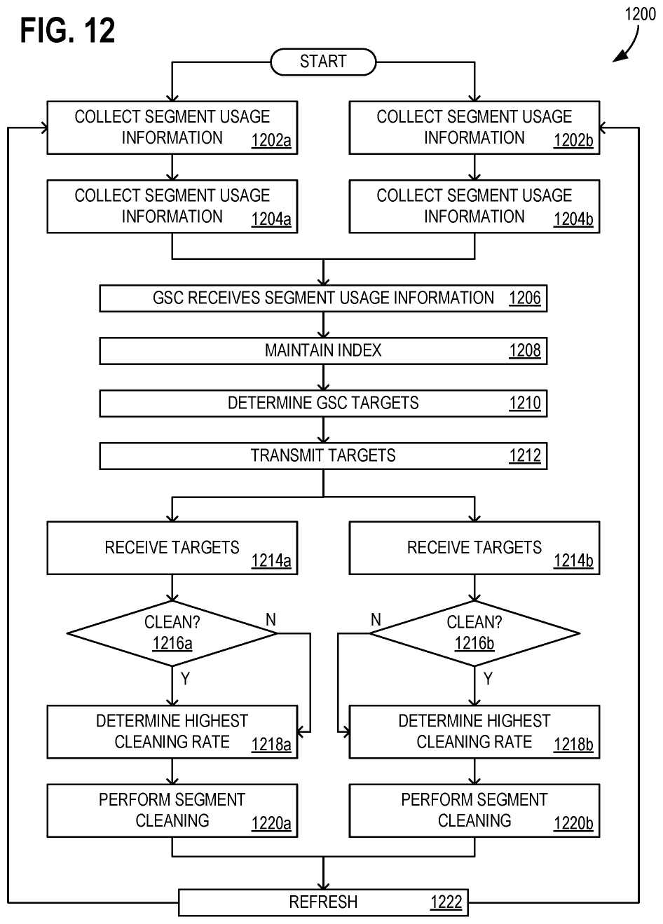

FIG. 12 illustrates a flowchart 1200 of exemplary operations performed by examples of architecture 100. In some examples, the operations of flowchart 1200 are performed by one or more computing apparatus 1518 of FIG. 15. Flowchart 1200 commences with operations 1202a and 1202b commencing in parallel. Object 102a performs operations 1202a, 1204a, and 1214a-1220a, whereas object 102b performs operations 1202b, 1204b, and 1214b-1220b. Object 102c performs yet another corresponding set of operations (not shown).

In operation 1202a, object 102a (specifically, LSC 600a, in some examples) collects segment usage information 120 of LFS 400a, which includes segment usage metric 512a and maximum cleaning rate 518a. That is, maximum cleaning rate 518a is determined as part of operation 1202a. In operation 1204a, object 102a transmits segment usage information 120 to the GSCs of each of plurality of storage disks 104a, which in the disclosed example, are GSCs 700a and 700b. In operation 1202b, object 102b (specifically, LSC 600b, in some examples) collects segment usage information 120 of LFS 400b, which includes segment usage metric 512b and maximum cleaning rate 518b. In operation 1204b, object 102b transmits segment usage information 120 to the GSCs of each of plurality of storage disks 104b, which in the disclosed example, are GSCs 700a-700c.

GSC 700a performs operations 1206-1212, while GSCs 700b and 700c perform equivalent operations in parallel. In operation 1206, GSC 700a receives segment usage information 120 for LFS 400a, which includes segment usage metric 512a and maximum cleaning rate 518a, from object 102a, and receives segment usage information 120 for LFS 400b, which includes segment usage metric 512b and maximum cleaning rate 518b, from object 102b. GSC 700a maintains and updates index 702a of objects with a presence on storage disk 110a, in operation 1208. In operation 1210, GSC 700a determines target segment usage metric 704a and target cleaning rate 706a. Operation 1210 is performed by using or determining maximum cleaning rates 518a and 518b. GSC 700a transmits target segment usage metric 704a and target cleaning rate 706a to objects 102a and 102b in operation 1212. In some examples, this is performed using cluster management service 124.

In operation 1214a, object 102a receives target segment usage metric 704a and target cleaning rate 706a from GSC 700a, and receives target segment usage metric 704b and target cleaning rate 706b from GSC 700b. Decision operation 1216a determines whether segment usage metric 512a is below either of target segment usage metrics 704a and 704b. If so, operation 1218a determines the higher of target cleaning rates 706a and 706b. Selected cleaning rate 620a is set to the highest of target cleaning rates 706a and 706b and the cleaning rate determined by flowchart 1100. In some examples, even if segment usage metric 512a is above both of target segment usage metrics 704a and 704b, and so no segment cleaning is needed based on coordinated cleaning parameters 630a, segment cleaning may nevertheless be needed based on GSC cleaning parameters 602a. If so, selected cleaning rate 620a is set to the cleaning rate determined by flowchart 1100. Operation 1220a performs segment cleaning of LFS 400a. In some examples, operation 1220a is the same as operation 1118 of flowchart 1100.

In operation 1214b, object 102b receives target segment usage metric 704a and target cleaning rate 706a from GSC 700a, receives target segment usage metric 704b and target cleaning rate 706b from GSC 700b, and receives target segment usage metric 704c and target cleaning rate 706c from GSC 700c. Decision operation 1216b determines whether segment usage metric 512b is below any of target segment usage metrics 704a-704c. If so, operation 1218b determines the highest of target cleaning rates 706a-706c. Selected cleaning rate 620b is set to the highest of target cleaning rates 706a-706c and the cleaning rate determined by flowchart 1100 (but for LFS 400b). In some examples, even if segment usage metric 512b is above all of target segment usage metrics 704a-704c, and so no segment cleaning is needed based on coordinated cleaning parameters 630b, segment cleaning may nevertheless be needed based on GSC cleaning parameters 602b. If so, selected cleaning rate 620b is set to the cleaning rate determined by flowchart 1100. Operation 1220b performs segment cleaning of LFS 400b.

Operation 1222 performs a refresh on some trigger, such as a schedule or certain storage disk statistics conditions, and flowchart 1200 returns to operations 1202a and 1202b.

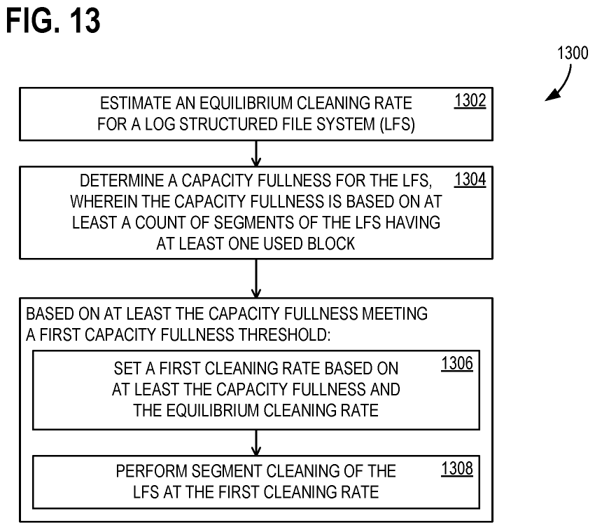

FIG. 13 illustrates a flowchart 1300 of exemplary operations that may be performed by examples of architecture 100. In some examples, the operations of flowchart 1300 are performed by one or more computing apparatus 1518 of FIG. 15. Flowchart 1300 commences with operation 1302, which includes estimating an equilibrium cleaning rate for an LFS.

Operation 1304 includes determining a capacity fullness for the LFS, wherein the capacity fullness is based on at least a count of segments of the LFS having at least one used block. Operation 1306 and 1308 are based on at least the capacity fullness meeting a first capacity fullness threshold. Operation 1306 includes setting a first cleaning rate based on at least the capacity fullness and the equilibrium cleaning rate. Operation 1308 includes performing segment cleaning of the LFS at the first cleaning rate.

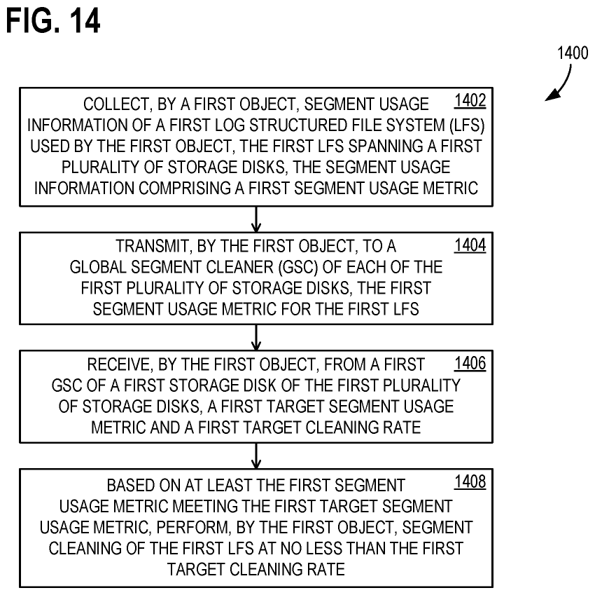

FIG. 14 illustrates a flowchart 1400 of exemplary operations that may be performed by examples of architecture 100. In some examples, the operations of flowchart 1400 are performed by one or more computing apparatus 1518 of FIG. 15. Flowchart 1400 commences with operation 1402, which includes collecting, by a first object, segment usage information of a first LFS used by the first object, the first LFS spanning a first plurality of storage disks, the segment usage information comprising a first segment usage metric.

Operation 1404 includes transmitting, by the first object, to a GSC of each of the first plurality of storage disks, the first segment usage metric for the first LFS. Operation 1406 includes receiving, by the first object, from a first GSC of a first storage disk of the first plurality of storage disks, a first target segment usage metric and a first target cleaning rate. Operation 1408 includes, based on at least the first segment usage metric meeting (e.g., being no greater than) the first target segment usage metric, performing, by the first object, segment cleaning of the first LFS at no less than the first target cleaning rate.

### Additional Examples

An example computerized method comprises: estimating an equilibrium cleaning rate for an LFS; determining a capacity fullness for the LFS, wherein the capacity fullness is based on at least a count of segments of the LFS having at least one used block; and based on at least the capacity fullness meeting a first capacity fullness threshold: setting a first cleaning rate based on at least the capacity fullness and the equilibrium cleaning rate; and performing segment cleaning of the LFS at the first cleaning rate.

Another example computerized method comprises: collecting, by a first object, segment usage information of a first LFS used by the first object, the first LFS spanning a first plurality of storage disks, the segment usage information comprising a first segment usage metric; transmitting, by the first object, to a GSC of each of the first plurality of storage disks, the first segment usage metric for the first LFS; receiving, by the first object, from a first GSC of a first storage disk of the first plurality of storage disks, a first target segment usage metric and a first target cleaning rate; and based on at least the first segment usage metric being no greater than the first target segment usage metric, performing, by the first object, segment cleaning of the first LFS at no less than the first target cleaning rate.

An example system comprises: an LSC estimating an equilibrium cleaning rate for an LFS; the LSC determining a capacity fullness for the LFS, wherein the capacity fullness is based on at least a count of segments of the LFS having at least one used block; and based on at least the capacity fullness meeting a first capacity fullness threshold, the LSC: setting a first cleaning rate based on at least the capacity fullness and the equilibrium cleaning rate; and performing segment cleaning of the LFS at the first cleaning rate.

Another example system comprises: a first object collecting segment usage information of a first LFS used by the first object, the first LFS spanning a first plurality of storage disks, the segment usage information comprising a first segment usage metric; the first object transmitting, to a GSC of each of the first plurality of storage disks, the first segment usage metric for the first LFS; the first object receiving, from a first GSC of a first storage disk of the first plurality of storage disks, a first target segment usage metric and a first target cleaning rate; and based on at least the first segment usage metric being no greater than the first target segment usage metric, the first object performing segment cleaning of the first LFS at no less than the first target cleaning rate.

One or more example non-transitory computer storage media have computer-executable instructions that, upon execution by a processor, cause the processor to at least: estimate an equilibrium cleaning rate for an LFS; determine a capacity fullness for the LFS, wherein the capacity fullness is based on at least a count of segments of the LFS having at least one used block; and based on at least the capacity fullness meeting a first capacity fullness threshold: set a first cleaning rate based on at least the capacity fullness and the equilibrium cleaning rate; and perform segment cleaning of the LFS at the first cleaning rate.

One or more additional example non-transitory computer storage media have computer-executable instructions that, upon execution by a processor, cause the processor to at least: collect, by a first object, segment usage information of a first LFS used by the first object, the first LFS spanning a first plurality of storage disks, the segment usage information comprising a first segment usage metric; transmit, by the first object, to a GSC of each of the first plurality of storage disks, the first segment usage metric for the first LFS; receive, by the first object, from a first GSC of a first storage disk of the first plurality of storage disks, a first target segment usage metric and a first target cleaning rate; and based on at least the first segment usage metric being no greater than the first target segment usage metric, perform, by the first object, segment cleaning of the first LFS at no less than the first target cleaning rate.

Alternatively, or in addition to the other examples described herein, examples include any combination of the following:
based on at least the capacity fullness being below the first capacity fullness threshold, the LSC determines, within the LFS, a set of low usage segments having a segment fullness below a segment fullness threshold;
the segment fullness is based on at least a count of used blocks of the segment;
the LSC performs segment cleaning of low usage segments at an idle cleaning rate;
the idle cleaning rate is proportional to fullness of the segments;
based on at least the capacity fullness being below a second capacity fullness threshold, the LSC does not perform segment cleaning;
the LFS spans a plurality of storage disks;
a disk balancer determining a raw usage of a first storage disk of the plurality of storage disks;
the raw usage of the first storage disk is based on at least a count of used blocks of the first storage disk;
the disk balancer determining a raw usage of a second storage disk of the plurality of storage disks;
the raw usage of the second storage disk is based on at least a count of used blocks of the second storage disk;
based on at least the raw usage of the first storage disk exceeding a first rebalancing threshold and the raw usage of the first storage disk exceeding the raw usage of the second storage disk by a second rebalancing threshold, the disk balancer moving data from the first storage disk to the second storage disk;
the equilibrium cleaning rate is estimated based on at least a net write rate;
the first cleaning rate is a piecewise linear function of the capacity fullness;
the first cleaning rate is 50 percent (%) of the equilibrium cleaning rate at a capacity fullness of 80%;
the first cleaning rate is 100% of the equilibrium cleaning rate at a capacity fullness of 85% percent;
the first cleaning rate exceeds 100% of the equilibrium cleaning rate at a capacity fullness of 90% percent;
the LFS provides a persistent storage solution for a VM;
the equilibrium cleaning rate is further based on at least a segment freeing rate;
the LFS uses 4 kb blocks;
the LFS uses 512 kb segments;
each segment comprises 128 4 kb blocks;
the first capacity fullness threshold is 80 percent;
the second capacity fullness threshold is 50 percent;
the segment fullness threshold is 50 percent;
the first cleaning rate is 200% of the equilibrium cleaning rate at a capacity fullness of 90% percent;
the first storage disk and the second storage disk each comprises a physical storage disk;
the first segment usage metric meets the first target segment usage metric when the first segment usage metric is no greater than the first target segment usage metric
the first GSC receiving, from the first object, the first segment usage metric for the first LFS;
the first GSC receiving, from a second object, a second segment usage metric for a second LFS of the second object;
based on at least the received segment usage metrics, the first GSC determining the first target segment usage metric and the first target cleaning rate;
the first GSC transmitting to the first object and the second object, the first target segment usage metric and the first target cleaning rate;
the first object receiving, from a second GSC of a second storage disk of the first plurality of storage disks, a second target segment usage metric and a second target cleaning rate;
the first object determining that the second target cleaning rate exceeds the first target cleaning rate;
performing segment cleaning of the first LFS at no less than the first target cleaning rate comprises performing segment cleaning of the first LFS at the second target cleaning rate;
the first segment usage metric comprises an average segment fullness metric for each segment of the first LFS having a segment fullness within a histogram bin of a histogram of segment fullness values for the first LFS;
the histogram bin is a lowest histogram bin having a threshold count of segment fullness values;
the first object transmitting, to the GSC of each of the first plurality of storage disks, the histogram of segment fullness values for the first LFS;
the second object transmitting, to a GSC of each of a second plurality of storage disks, a histogram of segment fullness values for the second LFS;
the first plurality of storage disks overlaps the second plurality of storage disks by at least the first storage disk;
the second object receiving, from the first GSC, the first target segment usage metric and the first target cleaning rate;
the second object receiving, from a third GSC of the second plurality of storage disks, a third target segment usage metric and a third target cleaning rate;
determining, by the first GSC, a GSC target cleaning rate based on at least a net incoming write rate;
determining, by the first GSC, the first target cleaning rate based on at least a number of objects identified to perform segment cleaning;
based on at least the second segment usage metric meeting either the first target segment usage metric or the third target segment usage metric, the second object performing segment cleaning of the second LFS at the greater of than the first target cleaning rate and the third target cleaning rate;
the first object comprises a sub-object of a full storage object, and wherein the full storage object comprises a plurality of sub-objects that each uses a different plurality of storage disks;
the first GSC maintains an index of objects with a presence on the first storage disk;
the first GSC maintains a Red-Black tree of objects with a presence on the first storage disk;
the Red-Black tree is ordered according to the average segment fullness metric of each object with a presence on the first storage disk;
determining the first target segment usage metric comprises determining a maximum cleaning rate of objects with a presence on the first storage disk;
transmitting the first segment usage metric comprises transmitting the first segment usage metric to components of each of the first plurality of storage disks; and
transmitting the first target segment usage metric and the first target cleaning rate comprises transmitting the first target segment usage metric and the first target cleaning rate using a cluster management service.

### Exemplary Operating Environment

The present disclosure is operable with a computing device (computing apparatus) according to an embodiment shown as a functional block diagram 1500 in FIG. 15. In an embodiment, components of a computing apparatus 1518 may be implemented as part of an electronic device according to one or more embodiments described in this specification. The computing apparatus 1518 comprises one or more processors 1519 which may be microprocessors, controllers, or any other suitable type of processors for processing computer executable instructions to control the operation of the electronic device. Alternatively, or in addition, the processor 1519 is any technology capable of executing logic or instructions, such as a hardcoded machine. Platform software comprising an operating system 1520 or any other suitable platform software may be provided on the computing apparatus 1518 to enable application software 1521 (program code) to be executed by one or more processors 1519. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1518. Non-transitory computer-readable media (computer storage media) may include, for example, computer storage media such as a memory 1522 and communications media. Computer storage media, such as a memory 1522, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal per se. Propagated signals per se are not examples of computer storage media. Although the computer storage medium (the memory 1522) is shown within the computing apparatus 1518, it will be appreciated by a person skilled in the art, that the storage may be distributed or located remotely and accessed via a network or other communication link (e.g. using a communication interface 1523). Computer storage media are tangible, non-transitory, and are mutually exclusive to communication media.

The computing apparatus 1518 may comprise an input/output controller 1524 configured to output information to one or more output devices 1525, for example a display or a speaker, which may be separate from or integral to the electronic device. The input/output controller 1524 may also be configured to receive and process an input from one or more input devices 1526, for example, a keyboard, a microphone, or a touchpad. In one embodiment, the output device 1525 may also act as the input device. An example of such a device may be a touch sensitive display. The input/output controller 1524 may also output data to devices other than the output device, e.g. a locally connected printing device. In some embodiments, a user may provide input to the input device(s) 1526 and/or receive output from the output device(s) 1525.

The functionality described herein can be performed, at least in part, by one or more hardware logic components. According to an embodiment, the computing apparatus 1518 is configured by the program code when executed by the processor 1519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided, such as via a dialog box or preference setting, to the users of the collection of the data (e.g., the operational metadata) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method comprising:
estimating an equilibrium cleaning rate for a log structured file system (LFS);
determining a capacity fullness for the LFS, wherein the capacity fullness is based on at least a count of segments of the LFS having at least one used block; and
based on at least the capacity fullness meeting a first capacity fullness threshold:
setting a first cleaning rate based on at least the capacity fullness and the equilibrium cleaning rate; and
performing segment cleaning of the LFS at the first cleaning rate.

2. The computerized method of claim 1, further comprising:
based on at least the capacity fullness being below the first capacity fullness threshold:
determining, within the LFS, a set of low usage segments having a segment fullness below a segment fullness threshold, wherein the segment fullness is based on at least a count of used blocks of the segment; and
performing segment cleaning of segments within the set of low usage segments at an idle cleaning rate.

3. The computerized method of claim 1, further comprising:
based on at least the capacity fullness being below a second capacity fullness threshold, deciding to not perform segment cleaning.

4. The computerized method of claim 1, wherein the LFS spans a plurality of storage disks, and wherein the method further comprises:
determining a raw usage of a first storage disk of the plurality of storage disks, wherein the raw usage of the first storage disk is based on at least a count of used blocks of the first storage disk;
determining a raw usage of a second storage disk of the plurality of storage disks, wherein the raw usage of the second storage disk is based on at least a count of used blocks of the second storage disk; and
based on at least the raw usage of the first storage disk exceeding a first rebalancing threshold and the raw usage of the first storage disk exceeding the raw usage of the second storage disk by a second rebalancing threshold, moving data from the first storage disk to the second storage disk.

5. The computerized method of claim 1, wherein the equilibrium cleaning rate is estimated based on at least a net write rate.

6. The computerized method of claim 1, wherein the first cleaning rate is a piecewise linear function of the capacity fullness.

7. The computerized method of claim 6, wherein the first cleaning rate is 50% of the equilibrium cleaning rate at a capacity fullness of 80%, wherein the first cleaning rate is 100% of the equilibrium cleaning rate at a capacity fullness of 85% percent, and wherein the first cleaning rate exceeds 100% of the equilibrium cleaning rate at a capacity fullness of 90% percent.

8. A system comprising:
a local segment cleaner (LSC) estimating an equilibrium cleaning rate for a log structured file system (LFS);
the LSC determining a capacity fullness for the LFS, wherein the capacity fullness is based on at least a count of segments of the LFS having at least one used block; and
based on at least the capacity fullness meeting a first capacity fullness threshold, the LSC:
setting a first cleaning rate based on at least the capacity fullness and the equilibrium cleaning rate; and
performing segment cleaning of the LFS at the first cleaning rate.

9. The system of claim 8, wherein:
based on at least the capacity fullness being below the first capacity fullness threshold:
the LSC determines, within the LFS, a set of low usage segments having a segment fullness below a segment fullness threshold, wherein the segment fullness is based on at least a count of used blocks of the segment; and
the LSC performs segment cleaning of segments, that are within the set of low usage segments, at an idle cleaning rate.

10. The system of claim 8, wherein:
based on at least the capacity fullness being below a second capacity fullness threshold, the LSC determines to not perform segment cleaning.

11. The system of claim 8, wherein the LFS spans a plurality of storage disks, and wherein the system further comprises:
a disk balancer determining a raw usage of a first storage disk of the plurality of storage disks, wherein the raw usage of the first storage disk is based on at least a count of used blocks of the first storage disk;
the disk balancer determining a raw usage of a second storage disk of the plurality of storage disks, wherein the raw usage of the second storage disk is based on at least a count of used blocks of the second storage disk; and
based on at least the raw usage of the first storage disk exceeding a first rebalancing threshold and the raw usage of the first storage disk exceeding the raw usage of the second storage disk by a second rebalancing threshold, the disk balancer moving data from the first storage disk to the second storage disk.

12. The system of claim 8, wherein the equilibrium cleaning rate is estimated based on at least a net write rate.

13. The system of claim 8, wherein the first cleaning rate is a piecewise linear function of the capacity fullness.

14. The system of claim 13, wherein the first cleaning rate is 50% of the equilibrium cleaning rate at a capacity fullness of 80%, wherein the first cleaning rate is 100% of the equilibrium cleaning rate at a capacity fullness of 85% percent, and wherein the first cleaning rate exceeds 100% of the equilibrium cleaning rate at a capacity fullness of 90% percent.

15. One or more computer storage media having computer-executable instructions that, upon execution by a processor, cause the processor to at least:
estimate an equilibrium cleaning rate for a log structured file system (LFS);
determine a capacity fullness for the LFS, wherein the capacity fullness is based on at least a count of segments of the LFS having at least one used block; and
based on at least the capacity fullness meeting a first capacity fullness threshold:
set a first cleaning rate based on at least the capacity fullness and the equilibrium cleaning rate; and
perform segment cleaning of the LFS at the first cleaning rate.

16. The computer storage media of claim 15, wherein the computer-executable instructions, upon execution by a processor, further cause the processor to at least:
based on at least the capacity fullness being below the first capacity fullness threshold:
determine, within the LFS, a set of low usage segments having a segment fullness below a segment fullness threshold, wherein the segment fullness is based on at least a count of used blocks of the segment; and
perform segment cleaning of segments that are within the set of low usage segments at an idle cleaning rate.

17. The computer storage media of claim 15, wherein the computer-executable instructions, upon execution by a processor, further cause the processor to at least:
based on at least the capacity fullness being below a second capacity fullness threshold, not perform segment cleaning.

18. The computer storage media of claim 15, wherein the LFS spans a plurality of storage disks, and wherein the computer-executable instructions, upon execution by a processor, further cause the processor to at least:
determine a raw usage of a first storage disk of the plurality of storage disks, wherein the raw usage of the first storage disk is based on at least a count of used blocks of the first storage disk;
determine a raw usage of a second storage disk of the plurality of storage disks, wherein the raw usage of the second storage disk is based on at least a count of used blocks of the second storage disk; and
based on at least the raw usage of the first storage disk exceeding a first rebalancing threshold and the raw usage of the first storage disk exceeding the raw usage of the second storage disk by a second rebalancing threshold, move data from the first storage disk to the second storage disk.

19. The computer storage media of claim 15, wherein the equilibrium cleaning rate is estimated based on at least a net write rate.

20. The computer storage media of claim 15, wherein the equilibrium cleaning rate is a piecewise linear function of the capacity fullness.
